(19) United States
(12) Patent Application Publication
(10) Pub. No.: US 2026/0149477 A1
(43) Pub. Date: May 28, 2026

(54) SIGNAL PROCESSING APPARATUS, SIGNAL PROCESSING METHOD, AND NON-TRANSITORY RECORDING MEDIUM

(71) Applicant: NEC Corporation, Tokyo (JP)

(72) Inventor: Norifumi KAMIYA, Tokyo (JP)

(73) Assignee: NEC Corporation, Tokyo (JP)

(21) Appl. No.: 19/385,303

(22) Filed: Nov. 11, 2025

(30) Foreign Application Priority Data
Nov. 28, 2024 (JP) 2024-207335

(51) Int. Cl. H04B 1/12; H04L 27/36

(52) U.S. Cl. CPC H04B 1/12; H04L 27/36

(57) ABSTRACT

The system includes D MISO filters and D interference cancellation filters, and multiple received signal sequences are D first received signal sequences. Each of i-th (i is an integer between 1 and D) MISO filters included in the D MISO filters receives i-th D received signal sequence as input and estimates i-th single transmitted signal sequence included in D transmitted signal sequences. Each of i-th interference cancellation filters included in the D interference cancellation filters receives a signal obtained by transforming i-th single estimated transmitted signal sequence, which is the estimation result of i-th single transmitted signal sequence, through phase correction processing and noise compensation processing, and the i-th D received signal sequence. The system cancels interference signals included in the i-th D received signal sequence, outputs the i+1-th D received signal sequence, and estimates D transmitted signal sequences including the i-th single transmitted signal sequence.

### INCORPORATION BY REFERENCE

This application is based upon and claims the benefit of priority from Japanese Patent Application No. 2024-207335, filed on Nov. 28, 2024, the disclosure of which is incorporated herein in its entirety by reference.

### TECHNICAL FIELD

This disclosure relates to a signal processing apparatus, a signal processing method, and a non-transitory recording medium capable of estimating plurality of corresponding transmitted signal sequences from plurality of spatially multiplexed received signal sequences.

### BACKGROUND ART

Demand for information transmission systems using optical fiber transmission technology or wireless transmission technology as communication infrastructure is increasing. Along with this increased demand, there is a requirement for higher transmission capacity. In this context, transmission technology using multi-core optical fibers with multiple cores is gaining attention in optical fiber transmission. Multi-Core Fiber (MCF) technology achieves increased communication capacity by allowing cross-talk (XT) between cores to increase core density. The introduction of MCF technology into long-distance transmission systems, such as optical submarine cables, is anticipated.

In coupled MCF transmission, MIMO equalization processing is essential. This processing compensates for XT between cores and aims to estimate a plurality of transmitted signals corresponding to a plurality of received signal sequences. One example of MIMO equalization processing is signal estimation processing using linear equalizers. In this case, the filter coefficients (tap coefficients) of each linear equalizer are optimized to minimize the error between the plurality of estimated transmitted signals from the signal estimation processing and the actual transmitted plurality of transmitted signals. For example, one type of signal estimation processing is MMSE (Minimum Mean Square Error) estimation processing. This uses a linear equalizer whose filter coefficients (tap coefficients) are optimized to minimize the least squares error between the plurality of estimated transmitted signals from the signal estimation processing and the actual transmitted plurality of transmitted signals.

While MMSE processing offers the advantage of reduced computational cost through the LMS (Least Mean Square) algorithm, it presents the technical challenge of having room for improvement in the estimation accuracy of plurality of received signals. As an example of a technology enabling such improvement in received signal estimation accuracy, Japanese Patent Application Publication No. 2017-11577 discloses a successive interference cancellation technique. This technique assumes sequential estimation of plurality of received signals one by one. It generates replicas of interfering signals from one estimated transmitted signal and improves the estimation accuracy of the next received signal to be estimated by subtracting the replicas of interfering signals from the received signal.

### SUMMARY

Although MMSE estimation processing offers advantages in computational cost, it presents a technical challenge in that the estimation accuracy of plurality of transmitted signals is not optimal and has room for improvement. On the other hand, the aforementioned successive interference cancellation technology enables improvement in the estimation accuracy of transmitted signals. However, it requires determining the order of sequential processing, calculating filter coefficients to estimate transmitted signals, and calculating filter coefficients to remove interfering signals. Furthermore, in case where the transmitted signal estimated in the preceding stage contains errors, the accuracy of the interfering signals removal processing performed based on that signal degrades. This leads to the problem of error propagation, adversely affecting the estimation of transmitted signals in subsequent stages. This disclosure aims to provide MIMO signal estimation and filter coefficient optimization capable of resolving such technical issues.

A signal processing apparatus according to an example aspect that estimates a plurality of transmitted signal sequences corresponding each of a plurality of spatially multiplexed received signal sequences that interfere with each other, from the plurality of received signal sequences, the signal processing apparatus includes: D (D is a positive integer) multiple-input single-output (MISO) filters, each of the D MIMO filters receives as input D data sequences, same number as the number of the plurality of received signal sequences, and outputs a single data sequence; D interference cancellation filters, each of the D interference cancellation filters receives as input a single data sequence and D data sequences, and cancels interfering signals from the D data sequences using the single data sequence; wherein the plurality of received signal sequences is first D received signal sequences, each i-th (i is an integer between 1 and D) MISO filter included in the D MISO filters receives as input i-th D received signal sequences, and estimates a i-th single transmitted signal sequence included in D transmitted signal sequences, each i-th interference cancellation filter included in the D interference cancellation filters receives as input a signal obtained by transforming a i-th single estimated transmitted signal sequence, which is an estimation result of the i-th single transmitted signal sequence, through a phase correction processing and a noise correction processing, and the i-th D received signal sequences, and cancels interference signals included in the i-th D received signal sequences, thereby outputting a i+1th D received signal sequences, and the signal processing apparatus estimating the D transmitted signal sequences including the i-th single transmitted signal sequence.

A signal processing method according to an example aspect executed by a signal processing apparatus that estimates a plurality of transmitted signal sequences corresponding each of a plurality of spatially multiplexed received signal sequences that interfere with each other, from the plurality of received signal sequences, the signal processing apparatus includes: D (D is a positive integer) multiple-input single-output (MISO) filters, each of the D MIMO filters receives as input D data sequences, same number as the number of the plurality of received signal sequences, and outputs a single data sequence; D interference cancellation filters, each of the D interference cancellation filters receives as input a single data sequence and D data sequences, and cancels interfering signals from the D data sequences using the single data sequence; wherein the plurality of received signal sequences is first D received signal sequences, the signal processing method includes: by each i-th (i is an integer between 1 and D) MISO filter included in the D MISO filters, receiving as input i-th D received signal sequences, and estimating a i-th single transmitted signal sequence included in D transmitted signal sequences; by each i-th interference cancellation filter included in the D interference cancellation filters, receiving as input a signal obtained by transforming a i-th single estimated transmitted signal sequence, which is an estimation result of the i-th single transmitted signal sequence, through a phase correction processing and a noise correction processing, and the i-th D received signal sequences, and canceling interference signals included in the i-th D received signal sequences, thereby outputting a i+1th D received signal sequences; and estimating the D transmitted signal sequences including the i-th single transmitted signal sequence.

A non-transitory recording medium according to an example aspect is a recording medium on which a non-transitory recording medium that allows a computer to execute a signal processing method is recorded, the signal processing method including: executed by a signal processing apparatus that estimates a plurality of transmitted signal sequences corresponding each of a plurality of spatially multiplexed received signal sequences that interfere with each other, from the plurality of received signal sequences, the signal processing apparatus includes: D (D is a positive integer) multiple-input single-output (MISO) filters, each of the D MIMO filters receives as input D data sequences, same number as the number of the plurality of received signal sequences, and outputs a single data sequence; D interference cancellation filters, each of the D interference cancellation filters receives as input a single data sequence and D data sequences, and cancels interfering signals from the D data sequences using the single data sequence; wherein the plurality of received signal sequences is first D received signal sequences, the signal processing method includes: by each i-th (i is an integer between 1 and D) MISO filter included in the D MISO filters, receiving as input i-th D received signal sequences, and estimating a i-th single transmitted signal sequence included in D transmitted signal sequences; by each i-th interference cancellation filter included in the D interference cancellation filters, receiving as input a signal obtained by transforming a i-th single estimated transmitted signal sequence, which is an estimation result of the i-th single transmitted signal sequence, through a phase correction processing and a noise correction processing, and the i-th D received signal sequences, and canceling interference signals included in the i-th D received signal sequences, thereby outputting a i+1th D received signal sequences; and estimating the D transmitted signal sequences including the i-th single transmitted signal sequence.

According to the respective embodiments of the signal processing apparatus, signal processing method, and non-transitory recording medium described above, the estimation accuracy of the transmitted signal can be improved.

### BRIEF DESCRIPTION OF THE DRAWINGS

FIG. 1 is a block diagram showing the configuration of the transmission system in this example embodiment.

FIG. 2 is a block diagram showing the configuration of the signal processing apparatus in this example embodiment.

FIG. 3 is a block diagram showing the configuration of the multiple-input single-output (MISO) filter.

FIG. 4 is a block diagram showing the configuration of the interference cancellation filter.

FIG. 5 is a block diagram showing the configuration of the noise correction apparatus.

FIG. 6 is a block diagram showing the configuration of the filter coefficient update apparatus.

FIG. 7 is a block diagram showing the configuration of the MISO filter coefficient update apparatus.

FIG. 8 is a block diagram showing the configuration of the interference cancellation filter coefficient update apparatus.

FIG. 9 is a block diagram showing the configuration of the signal processing apparatus in this example embodiment.

### EXAMPLE EMBODIMENTS

The following describes the example embodiments of the signal processing apparatus, signal processing method, and non-transitory recording medium while referring to the drawings. However, this disclosure is not limited to the examples described below.

### 1: First Example Embodiment

The first example embodiment of the signal processing apparatus, signal processing method, and non-transitory recording medium is described below.

### [1-1: Configuration of Transmission System SYS]

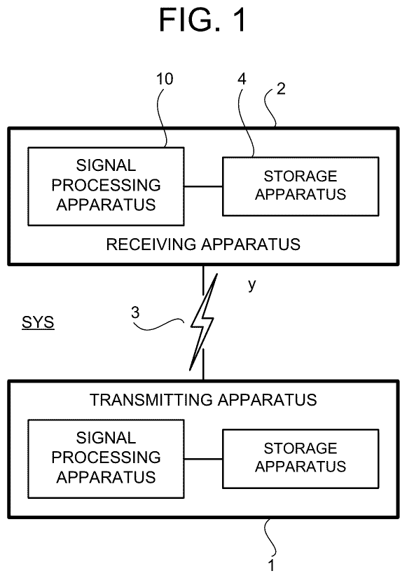

First, with reference to FIG. 1, the overall configuration of the transmission system SYS in this example embodiment is described. FIG. 1 is a block diagram showing the configuration of the transmission system SYS in this example embodiment.

As shown in FIG. 1, the transmission system SYS includes a transmitting apparatus 1 and a receiving apparatus 2. The transmitting apparatus 1 transmits a plurality of spatially multiplexed transmitted signals x via transmission path 3 to the receiving apparatus 2. The receiving apparatus 2 receives the plurality of transmitted signals x sent from the transmitting apparatus 1 via transmission path 3 as a plurality of received signals y. Each transmitted signal x may contain a plurality of signal components and may therefore be referred to as a transmitted signal sequence. Similarly, each received signal y may contain a plurality of signal components and may therefore be referred to as a received signal sequence.

To receive the received signal sequence y, the receiving apparatus 2 includes a signal processing apparatus 10 and a storage apparatus 4. The signal processing apparatus 10 includes a CPU (Central Processing Unit), a GPU (Graphics Processing Unit), and/or an FPGA (Field Programmable Gate Array). The signal processing apparatus 10 may read a computer program. For example, the signal processing apparatus 10 may read a computer program stored in the storage apparatus 4. For example, the signal processing apparatus 10 may read a computer program stored on a computer-readable recording medium using a recording medium reading apparatus (not shown). The signal processing apparatus 10 may acquire (i.e., download or load) a computer program from an unillustrated apparatus located outside the receiving apparatus 2 via an unillustrated communication apparatus. The signal processing apparatus 10 executes the loaded computer program. As a result, a logical functional block is realized within the signal processing apparatus 10 to perform the operation that the receiving apparatus 2 should perform. Specifically, within the signal processing apparatus 10, a logical functional block is implemented to perform the receiving operation of receiving the received signal sequence y. That is, the signal processing apparatus 10 can function as a controller to implement the logical functional blocks for performing the operations that the receiving apparatus 2 should perform.

The storage apparatus 4 is capable of storing desired data. For example, the storage apparatus 4 may temporarily store computer programs executed by the signal processing apparatus 10. The storage apparatus 4 may also temporarily store data used by the signal processing apparatus 10 during the execution of computer programs. The storage apparatus 4 may store data that the receiving apparatus 2 stores long-term. Note that the storage apparatus 4 may include at least one of RAM (Random Access Memory), ROM (Read-Only Memory), a hard disk apparatus, an optical magnetic disk apparatus, an SSD (Solid State Drive), and a disk array apparatus.

To transmit the transmitted signal sequence, the transmitting apparatus 1 may include a signal processing apparatus and a storage apparatus. The signal processing apparatus provided in the transmitting apparatus 1 may function similarly to the aforementioned the signal processing apparatus 10. The storage apparatus provided in the transmitting apparatus 1 may function similarly to the aforementioned the storage apparatus 4.

The transmission system SYS according to this example embodiment performs multi-core optical fiber transmission and communication using multiple antennas.

The receiving apparatus 2 performs a signal estimation processing to estimate the transmitted signal sequence from the received signal sequence y, as at least part of its receiving operation.

In the following description, the multiplexing factor of MIMO transmitted signal sequences is denoted as D, and the multiplexing factor of MIMO received signal sequences is also denoted as D (where D represents an integer of 2 or greater). Note that although similar processing is possible in case where the MIMO transmitted signal sequences multiplexing factor Dₜ and the MIMO received signal sequences multiplexing factor Dᵣ differ, the description becomes cumbersome. Therefore, the case where the MIMO transmitted signal sequences multiplexing factor Dₜ and the MIMO received signal sequences multiplexing factor Dᵣ are identical (D=Dₜ=Dᵣ) is described.

Each of the D transmitted signal sequences is a sequence composed of pre-set multi-level Quadratic Amplitude Modulation (QAM) signal points, each represented by a complex value. Hereafter, the i-th transmitted signal sequence of length N is denoted simply as x⁽ⁱ⁾ (where i is an integer between 1 and D, and N is an integer greater than or equal to 1), and the received signal sequence of length N is denoted simply as y⁽ⁱ⁾. Note that the N may be any positive integer; however, to avoid complexity, N=1 is used in the following description without loss of generality.

The D transmitted signal sequences constituting the MIMO transmitted signal sequences are denoted as x⁽¹⁾, x⁽²⁾, . . . , x^{(D)}, respectively. The D received signal sequences constituting the MIMO received signal sequences are denoted as y⁽¹⁾, y⁽²⁾, . . . , y^{(D)}, respectively. As mentioned earlier, each transmitted signal sequence is a complex-valued signal composed of QAM signal points, and each corresponding received signal sequence is also a complex-valued signal.

The D received signal sequences y⁽¹⁾, y⁽²⁾, . . . y^{(D)} are determined by the convolution of the D transmitted signal sequences x⁽¹⁾, x⁽²⁾, . . . , x^{(D)} with the D× D impulse response in the MIMO transmission channel, plus the addition of a white noise component. Under this premise, signal estimation processing may be performed.

### [2-1: Configuration of the Receiving Apparatus 2 (Signal Processing Apparatus 10)]

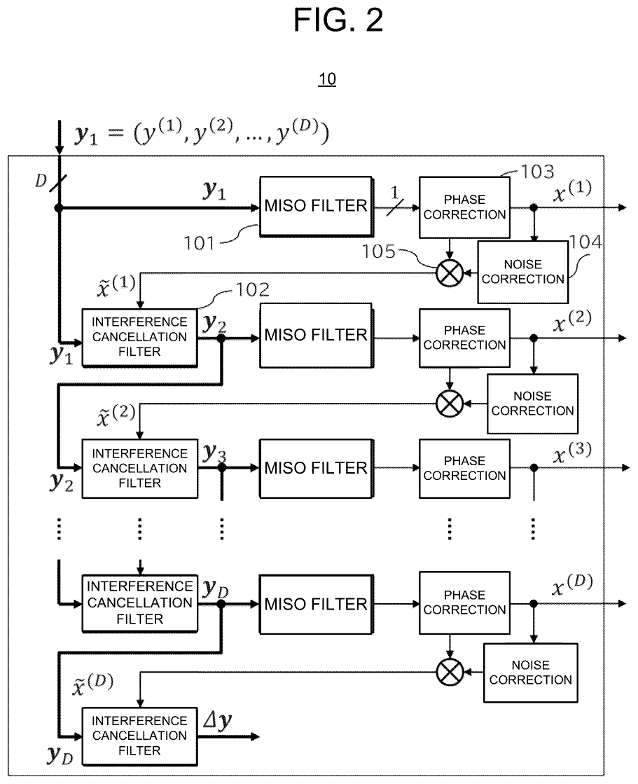

Referring to FIG. 2, the configuration of the receiving apparatus 2 (specifically, the configuration of signal processing apparatus 10) performing a signal sequence estimation processing is described. FIG. 2 is a block diagram showing the logical functional blocks implemented within the signal processing apparatus 10 to perform the signal estimation processing. The signal processing apparatus according to this example embodiment estimates, from D received signal sequences y⁽¹⁾, y⁽²⁾, . . . y^{(D)}, the D transmitted signal sequences x⁽¹⁾, x⁽²⁾, . . . x^{(D)} corresponding to each of the D received signal sequences. Therefore, the signal processing apparatus according to this example embodiment may be referred to as a MIMO signal sequence estimation apparatus.

As shown in FIG. 2, the MIMO signal sequence estimation apparatus 10 includes D multiple-input single-output (MISO) filter apparatuses 101, D interference cancellation filter apparatuses 102, D phase correction units 103, and D noise correction apparatuses 104. The D MISO filter apparatuses 101 and the D interference cancellation filter apparatuses 102 may be configured to be connected alternately via the phase correction unit 103 and the noise correction apparatus 104. Furthermore, the phase correction unit 103 may be a Phase Locked Loop (PLL).

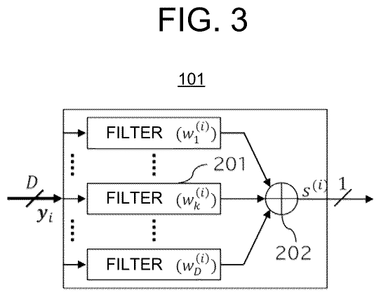

FIG. 3 shows an example configuration of the MISO filter apparatuses 101. As shown in FIG. 3, the MISO filter apparatuses 101 include D filters 201 and an adder 202. In the following description, to avoid complexity and without loss of generality, each the filter 201 is described as a length-1 Finite Impulse Response (FIR) filter.

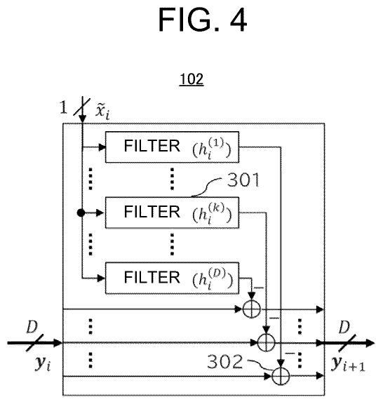

FIG. 4 shows an example configuration of the interference cancellation filter apparatuses 102. As shown in FIG. 4, the interference cancellation filter apparatuses 102 include D filters 301 and D subtractors 302. In the following description, similar to the MISO filter, to avoid complexity, each the filter 301 is described as a length-1 FIR filter.

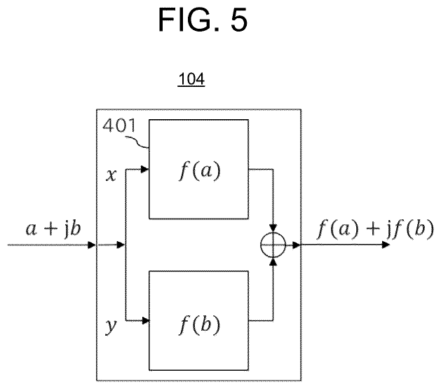

FIG. 5 shows an example configuration of the noise correction apparatus 104. As shown in FIG. 5, the noise correction apparatus 104 includes a transformation unit 401. As described earlier, the noise correction apparatus 104 receives a signal represented as a complex number. It decomposes this signal into real and imaginary parts, transforms it using the transformation unit 401, and then recomposes it into a complex number for output.

### [2-2: MIMO Signal Sequence Estimation Processing Flow]

Referring to FIG. 2, the operation of the MIMO signal sequence estimation processing in this example embodiment is described. The MIMO signal sequence estimation apparatus 10 estimates D transmitted signal sequences x⁽¹⁾, x⁽²⁾, . . . x^{(D)} one by one in a pre-set order. The order setting will be described later; for simplicity, the following explanation assumes estimation in the order x⁽¹⁾, x⁽²⁾, . . . x^{(D)}

First, the D received signal sequences y⁽¹⁾, y⁽²⁾, . . . y^{(D)} (denoted simply as y₁ in FIG. 2) are input to the first MISO filter apparatus 101. The coefficients of the D filters in the first MISO filter apparatus 101 are denoted as w₁⁽¹⁾, w₂⁽¹⁾, . . . , w_{D}⁽¹⁾, respectively. The first MISO filter apparatus 101 performs the operation shown in Formula 1 below and outputs the resulting signal s⁽¹⁾.

$${s}^{( 1 )} = {w}_{1}^{( 1 )} {y}^{( 1 )} + {w}_{2}^{( 1 )} {y}^{( 2 )} + ⋯ + {w}_{D}^{( 1 )} {y}^{( D )} = {\sum }_{k = 1}^{D} {w}_{k}^{( 1 )} {y}^{( k )} \qquad [ Formula 1 ]$$

The output signal s⁽¹⁾ from the first MISO filter apparatus 101 is input to the phase correction unit 103. The output signal s⁽¹⁾ from the first MISO filter apparatus 101 is corrected for the phase noise component by a phase rotation processing performed by the phase correction unit 103, resulting in an estimate of the first transmitted signal x⁽¹⁾. Note that the output signal from the phase correction unit 103 contains a noise component and is not necessarily the QAM signal point. Therefore, strictly speaking, the QAM signal point closest to the output signal of the phase correction unit 103 becomes the estimated result of the transmitted signal.

The output signal of the phase correction unit 103 is input to the noise correction apparatus 104. The noise correction apparatus 104 is an apparatus that converts the input signal into the QAM signal point or a signal close to the QAM signal point and outputs it. The noise correction apparatus 104 removes the noise component and outputs the extremely close QAM signal point in case where there is the QAM signal point extremely close to the input signal (i.e., the output signal of the phase correction unit 103). However, in case where there is no QAM signal point extremely close to the input signal, the noise correction apparatus does not completely remove the noise component and outputs a signal point somewhat distant from the QAM signal point closest to the input signal. This is a measure to reduce the impact in case where the determination of the transmitted signal point was erroneous, addressing the issue of error propagation that was a challenge in the successive interference cancellation method.

The signal output from the noise correction apparatus 104 undergoes the phase rotation processing that is the inverse of the phase rotation processing performed in the phase correction unit 103, and is input to the first interference cancellation filter apparatus 102. This input signal is denoted as \tilde{x}⁽¹⁾. In addition to this signal, D received signal sequences y⁽¹⁾, y⁽²⁾, . . . y^{(D)} are input to the first interference cancellation filter apparatus 102. The first interference cancellation filter apparatus 102 performs the operation shown in the following Formula 2, and the resulting y₂⁽¹⁾, y₂⁽²⁾, . . . y₂^{(D)} are the D output signals.

$${y}_{2}^{( 1 )} = {y}^{( 1 )} - {h}_{1}^{( 1 )} {\tilde{x}}^{( 1 )} \qquad [ Formula 2 ]$$

$${y}_{2}^{( 2 )} = {y}^{( 2 )} - {h}_{1}^{( 2 )} {\tilde{x}}^{( 1 )}$$

$$⋮$$

$${y}_{2}^{( D )} = {y}^{( D )} - {h}_{1}^{( D )} {\tilde{x}}^{( 1 )}$$

In Formula 2, h₁⁽¹⁾, h₁⁽²⁾, . . . , h₁^{(D)} are the coefficients of the D SIMO filters within the first interference cancellation filter apparatus 102, corresponding to the impulse response of the transmission channel.

The output signals y₂⁽¹⁾, y₂⁽²⁾, . . . y₂^{(D)} of the first interference cancellation filter apparatus 102 shown in the above Formula 2 are signals obtained by removing the interfering signals originating from the first transmitted signal x⁽¹⁾ from the received signals y⁽¹⁾, y⁽²⁾, . . . y^{(D)}, from the first transmitted signal x⁽¹⁾. Hereinafter, these are referred to as the second received signal sequences.

Similarly, for each integer i from 2 to D−1, the i-th MISO filter apparatus 101 receives the i-th received signal sequences yᵢ⁽¹⁾, yᵢ⁽²⁾, . . . yᵢ^{(D)}, performs the operation shown in the following Formula 3, and outputs the resulting signal s⁽ⁱ⁾.

$${s}^{( i )} = {w}_{1}^{( i )} {y}_{i}^{( 1 )} + {w}_{2}^{( i )} {y}_{i}^{( 2 )} + ⋯ + {w}_{D}^{( i )} {y}_{i}^{( D )} = {\sum }_{k = 1}^{D} {w}_{k}^{( i )} {y}_{i}^{( k )} \qquad [ Formula 3 ]$$

Note that in Formula 3, w₁⁽ⁱ⁾, w₂⁽ⁱ⁾, . . . , w_{D}⁽ⁱ⁾ are the coefficients of the i-th MISO filter apparatus 101. Similar to the processing applied to the output signal s⁽¹⁾ from the first MISO filter apparatus 101, the output signal s⁽ⁱ⁾ from the i-th MISO filter apparatus 101 is input to the phase correction unit 103. After the correction of the phase noise component by the phase correction unit 103, it becomes the estimated result of the i-th transmitted signal x⁽ⁱ⁾. Similarly, the output signal from the phase correction unit 103 is input to the noise correction apparatus 104, where the noise component is corrected, and then input to the i-th interference cancellation filter. This input signal is denoted as \tilde{x}⁽ⁱ⁾. In addition to this signal, the i-th received signal sequences yᵢ⁽¹⁾, yᵢ⁽²⁾, . . . yᵢ^{(D)} are input to the i-th interference cancellation filter apparatus 102. The i-th interference cancellation filter apparatus 102 performs the operation shown in the following Formula 4 and outputs D signals yᵢ₊₁⁽¹⁾, yᵢ₊₁⁽²⁾, . . . yᵢ₊₁^{(D)}.

$${y}_{i + 1}^{( 1 )} = {y}_{i}^{( 1 )} - {h}_{i}^{( 1 )} {\tilde{x}}^{( i )} \qquad [ Formula 4 ]$$

$${y}_{i + 1}^{( 2 )} = {y}_{i}^{( 2 )} - {h}_{i}^{( 2 )} {\tilde{x}}^{( i )}$$

$$⋮$$

$${y}_{i + 1}^{( D )} = {y}_{i}^{( D )} - {h}_{i}^{( D )} {\tilde{x}}^{( i )}$$

Note that in Formula 4, hᵢ⁽¹⁾, hᵢ⁽²⁾, . . . , hᵢ^{(D)} are the coefficients of the D SIMO filters within the i-th interference cancellation filter apparatus 102, corresponding to the impulse response of the transmission channel. The output signals yᵢ₊₁⁽¹⁾, yᵢ₊₁⁽²⁾, . . . yᵢ₊₁^{(D)} from the i-th interference cancellation filter apparatus 102 become the (i+1)-th received signal sequence.

Finally, the D-th MISO filter apparatus 101 receives the D-th received signal sequence y_{D}⁽¹⁾, y_{D}⁽²⁾, . . . y_{D}^{(D)} as input and outputs the output signal s (D) obtained through the operation shown in the following Formula 5.

$${s}^{( D )} = {w}_{1}^{( D )} {y}_{D}^{( 1 )} + {w}_{2}^{( D )} {y}_{D}^{( 2 )} + ⋯ + {w}_{D}^{( D )} {y}_{D}^{( D )} = {\sum }_{k = 1}^{D} {w}_{k}^{( D )} {y}_{D}^{( k )} \qquad [ Formula 5 ]$$

Note that in Formula 5, w₁^{(D)}, w₂^{(D)}, . . . , w_{D}^{(D)} are coefficients of the D-th MISO filter apparatus 101. The output signal s^{(D)} from the D-th MISO filter apparatus 101 is input to the phase correction unit 103. After the phase noise component is corrected by the phase correction unit 103, it becomes the estimated result of the D-th transmitted signal x^{(D)}.

As described above, through D rounds of MISO filter processing and D−1 rounds of interference cancellation filter processing, D transmitted signals x⁽¹⁾, x⁽²⁾, . . . , x^{(D)} are estimated one by one in sequence.

In addition to the above processing, the D-th interference cancellation filter apparatus 102 applies the phase rotation processing to the D-th estimated transmitted signal, which is the inverse of the phase rotation processing performed by the phase correction unit 103. \tilde{x}^{(D)} and the D-th received signal sequence y_{D}⁽¹⁾, y_{D}⁽²⁾, . . . y_{D}^{(D)}. It then calculates and outputs D signals Δy⁽¹⁾, Δy⁽²⁾, . . . Δy^{(D)} according to the following Formula 6.

$$Δ {y}^{( 1 )} = {y}_{D}^{( 1 )} - {h}_{D}^{( 1 )} {\tilde{x}}^{( D )} \qquad [ Formula 6 ]$$

$$Δ {y}^{( 2 )} = {y}_{D}^{( 2 )} - {h}_{D}^{( 2 )} {\tilde{x}}^{( D )}$$

$$⋮$$

$$Δ {y}^{( D )} = {y}_{D}^{( D )} - {h}_{D}^{( D )} {\tilde{x}}^{( D )}$$

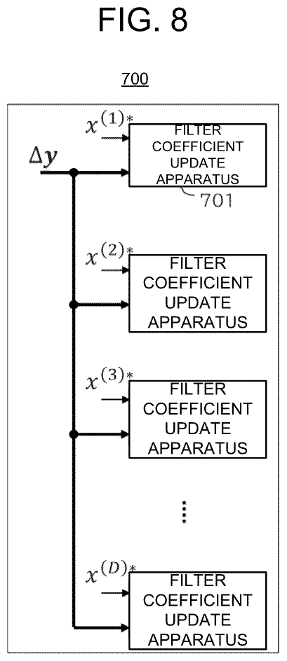

The D signals Δy⁽¹⁾, Δy⁽²⁾, . . . Δy^{(D)} obtained from the above Formula 6 are used in the filter coefficient update processing apparatus (FIG. 8) described later for calculating and updating the filter tap coefficients.

### [2-3: Configuration of the Multiple-Input Single-Output (MISO) Filter Processing Apparatus]

As explained in the flow of MIMO signal sequence estimation processing, the MISO filter apparatuses 101 are apparatus that execute the processing of Formulas 1, 3, and 5. One configuration example is shown in FIG. 3. As mentioned earlier, the MISO filter apparatuses 101 include D the filters 201 and one adder 202. Each of the D filters 201 multiplies the input signal y by the filter coefficient w and outputs the result of this multiplication. The adder 202 performs the processing of adding all the output signals from the D filters 201. It is clear that the processing of Formulas 1, 3, and 5 can be realized by the D filters 201 and the single adder 202.

### [2-4: Configuration of the Interference Cancellation Filter Processing Apparatus]

As explained in [MIMO signal sequence estimation processing flow], the interference cancellation filter apparatuses 102 are apparatuses that perform the processing of Formulas 2, 4, and 6. One configuration example is shown in FIG. 4. As mentioned earlier, the interference cancellation filter apparatuses 102 include D filters 301 and D subtractors 302. Each of the D filters 301 multiplies the input signal x by filter coefficient h and outputs the result. Furthermore, the subtractor 302 calculates the difference between an input signal x and the output of the filter. It is clear that the processing of Formulas 2, 4, and 6 can be realized by the D filters 301 and the D subtractors 302.

### [2-5: Configuration of the Noise Correction Processing Apparatus]

As explained in [MIMO Signal Sequence Estimation Processing Flow], the noise correction apparatus 104 is an apparatus that converts the input signal into the QAM signal point or a signal near the QAM signal point and outputs it. FIG. 5 shows one configuration example. The noise correction apparatus 104 shown in FIG. 5 receives a signal represented as a complex number and decomposes the signal into a real part (in-phase component) and an imaginary part (quadrature component). The noise correction apparatus converts the real part (in-phase component) and the imaginary part (quadrature component) using the transformation unit 401, then recombines them into a complex value for output. The transformation unit 401 outputs the function value f(a) shown in the following Formula 7 for the input real value a.

$$f ( a ) = {\sum }_{i = - q}^{q} ( - 1 + \frac{R e L U ( a - 2 i + γ )}{γ} - \frac{R e L U ( a - 2 i - γ )}{γ} ) \qquad [ Formula 7 ]$$

Note that in Formula 7, ReLU(x) is a function that outputs 0 in case where x is negative and outputs x as-is in case where x is 0 or positive; it is called the Rectified Linear Unit (ReLU). Furthermore, the I/Q components of the QAM signal points are set to {±1, ±3, . . . , ±(2Q+1)} (where q is a non-negative integer). In Formula 7, y is a parameter taking values between 0.0 and 1.0, which is set to an appropriate value beforehand. As described above, the function in Formula 7 is a nonlinear function characterized by being composed of the synthesis of the rectified linear unit (ReLU).

The configuration shown in FIG. 5, equipped with the transformation unit 401 that executes Formula 7, outputs the closest QAM signal point after removing the noise component in case where there is the QAM signal point extremely close to the input signal. Conversely, in case where there is no QAM signal point extremely close to the input signal, the noise component is not completely removed, and a signal point somewhat distant from the closest QAM signal point is output. The proximity of the extremely close QAM signal point and the signal point somewhat distant from the QAM signal point can be adjusted by setting the parameter y.

### [3: Filter Coefficient Update Method]

Next, the implementation method for updating the filter coefficients in the interference cancellation filter apparatuses 102 (FIG. 4) is described. However, this disclosure is not limited to the example embodiment described below.

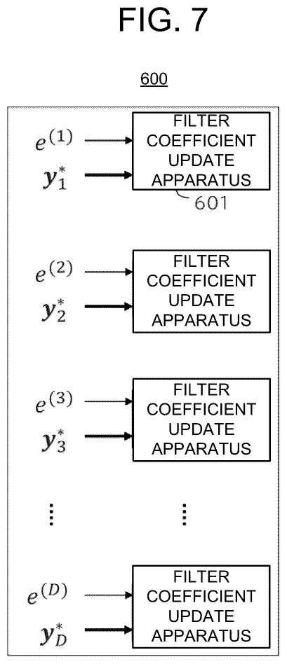

FIG. 7 is a block diagram showing one configuration example of a filter coefficient update apparatus 600 for the MISO filter. The MISO filter coefficient update apparatus 600 includes D filter coefficient update apparatuses, where D is equal to the number of the MISO filter apparatuses 101 provided by the MIMO signal sequence estimation apparatus 10 (FIG. 2).

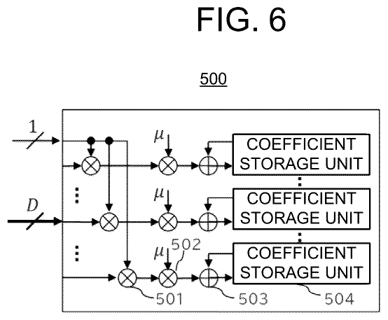

FIG. 6 is a block diagram showing an example configuration of a filter coefficient update apparatus 500, which has D filter coefficient storage units 504, D adders 503, D constant multipliers 502, and D multipliers 501.

The MISO filter coefficient update apparatus 600 shown in FIG. 7 receives the first through D-th received signal sequences y₁, y₂, . . . , y_{D}, which were the input signals to the D MISO filter apparatuses 101 in the MIMO signal sequence estimation apparatus 10, as well as error signals e⁽¹⁾, e⁽²⁾, . . . , e^{(D)} contained in the output signals of the D MISO filter apparatuses 101 in the MIMO signal sequence estimation apparatus 10. Furthermore, the error signals e⁽¹⁾, e⁽²⁾, . . . , e^{(D)} may be calculated using signals computed during the phase correction in the phase correction unit (PLL) 103.

In the D filter coefficient update apparatuses of the MISO filter coefficient update apparatus 600 shown in FIG. 7, the i-th filter coefficient update apparatus (where i is an integer between 1 and D) 601 uses the i-th error signal e⁽ⁱ⁾ from among the D error signals and the i-th received signal yᵢ=(yᵢ⁽¹⁾, yᵢ⁽²⁾, . . . , yᵢ^{(D)}) and its complex conjugate signal yᵢ*=(yᵢ⁽¹⁾*, yᵢ⁽²⁾*, . . . , yᵢ^{(D)}*) to update the D filter coefficients w₁⁽ⁱ⁾, w₂⁽ⁱ⁾, . . . , w_{D}⁽ⁱ⁾ in the i-th MISO filter apparatus according to the following Formula 8.

$${w}_{1}^{( i )} ← {w}_{1}^{( i )} + μ \cdot {e}^{( i )} \cdot {y}_{i}^{( 1 ) *} \qquad [ Formula 8 ]$$

$${w}_{2}^{( i )} ← {w}_{2}^{( i )} + μ \cdot {e}^{( i )} \cdot {y}_{i}^{( 2 ) *}$$

$$⋮$$

$${w}_{D}^{( i )} ← {w}_{D}^{( i )} + μ \cdot {e}^{( i )} \cdot {y}_{i}^{( D ) *}$$

Note that in Formula 8, μ is a real-valued parameter that has been pre-adjusted and set. The filter coefficient update apparatus in FIG. 6 performs a series of processes: reading the filter coefficients w₁⁽ⁱ⁾, w₂⁽ⁱ⁾, . . . , w_{D}⁽ⁱ⁾ stored in the D filter coefficient storage units 504, updating them according to the procedure in Formula 8, and then writing them back to the filter coefficient storage units 504.

As described above, the update of the filter coefficient in the i-th MISO filter apparatus is performed based on the error signal e⁽ⁱ⁾ contained in the output signal of the i-th MISO filter apparatus and the complex conjugate of the input signals yᵢ⁽¹⁾, yᵢ⁽²⁾, . . . , and yᵢ^{(D)}, through the processing described in Formula 8.

Next, the interference cancellation filter coefficient update apparatus 700 shown in FIG. 8 is described. The interference cancellation filter coefficient update apparatus 700 shown in FIG. 8 consists of D filter coefficient update apparatuses 701. Estimated signals x⁽¹⁾, x⁽²⁾, . . . x^{(D)} estimated by the MIMO signal sequence estimation apparatus 10, and the output signals Δy⁽¹⁾, Δy⁽²⁾, . . . Δy^{(D)} from the D-th interference cancellation filter.

The i-th filter coefficient update apparatus within the interference cancellation filter coefficient update apparatus 700 shown in FIG. 8 updates the SIMO filter coefficients hᵢ⁽¹⁾, hᵢ⁽²⁾, . . . , hᵢ^{(D)} in the i-th interference cancellation filter according to the following Formula 9.

$${h}_{i}^{( 1 )} ← {h}_{i}^{( 1 )} + μ \cdot {x}^{( 1 ) *} \cdot Δ {y}^{( 1 )} \qquad [ Formula 9 ]$$

$${h}_{i}^{( 2 )} ← {h}_{i}^{( 2 )} + μ \cdot {x}^{( 2 ) *} \cdot Δ {y}^{( 2 )}$$

$$⋮$$

$${h}_{i}^{( D )} ← {h}_{i}^{( D )} + μ \cdot {x}^{( D ) *} \cdot Δ {y}^{( D )}$$

Note that in Formula 9, μ is a real-valued parameter that is pre-adjusted and set. Although the same symbol as in Formula 8 is used, it need not be the same value. As described above, the update of the interference cancellation filter coefficient can be performed using the same procedure as the update of the MIMO filter coefficient.

### [4-1: Configuration and Operation of the Estimation Order Calculation Apparatus]

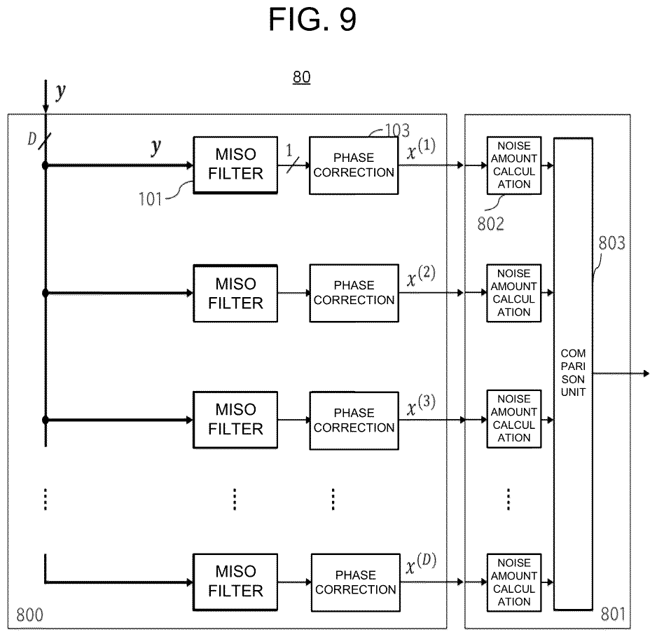

The MIMO signal sequence estimation apparatus 10 shown in FIG. 2 sequentially estimates each of the D transmitted signals. The number of possible ways to select this estimation order is the factorial of D (D!). A signal processing apparatus 80 in FIG. 9 is an apparatus for selecting the estimation order of transmitted signals. Its configuration and operational flow are described below.

FIG. 9 is a block diagram showing the configuration of the signal processing apparatus 80. The signal processing apparatus 80 includes a simple configuration MIMO signal sequence estimation apparatus 800, which omits the processing of the interference cancellation filter apparatuses 102 and the noise correction apparatus 104 shown in the MIMO signal sequence estimation apparatus 10 of FIG. 2, and an estimation order calculation apparatus 801. This simple configuration MIMO signal sequence estimation apparatus 800 need not be provided separately and may be shared with the MIMO signal sequence estimation apparatus 10 shown in FIG. 2.

The simple configuration MIMO signal sequence estimation apparatus 800 includes D MISO filter apparatuses 101 and D phase correction units 103. The input signals to the second through D-th MISO filters may be the same received signal sequences as the input signals to the first MISO filter.

Thus, the simple configuration MIMO signal sequence estimation apparatus 800 omits processing by the interference cancellation filter apparatuses 102 and the noise correction apparatus 104. Consequently, it requires no sequence specification and can estimate D transmitted signals simultaneously through parallel processing. However, compared to the configuration shown in FIG. 2, the estimation accuracy of the transmitted signals in the simple configuration MIMO signal sequence estimation apparatus 800 is reduced.

The estimation order calculation apparatus 801 shown in FIG. 9 includes D noise amount calculation units 802 and a comparison unit 803. Each of the D noise amount calculation units 802 receives as input the output signal from the corresponding D phase correction units 103 in the simple configuration MIMO signal sequence estimation apparatus 800. As mentioned earlier, the output signal from the phase correction unit 103 contains a noise component and is not necessarily the QAM signal point. More precisely, the QAM signal point closest to the output signal of the phase correction unit 103 becomes the estimated result of the transmitted signals. That is, the difference between the output signal of the phase correction unit 103 and the closest QAM signal point represents the magnitude of the noise component. The noise amount calculation unit 802 shown in FIG. 9 is an apparatus that calculates and outputs this magnitude of the noise component.

The comparison unit 803 shown in FIG. 9 receives the noise amount output by the D noise amount calculation units 802, compares each noise amount, sorts them in ascending order of noise amount, and outputs this sorted order. The order output by the comparison unit 803 is used as the order in which the MIMO signal sequence estimation apparatus shown in FIG. 2 sequentially estimates the D transmitted signals one by one.

During the initial phase of data transmission, the simple configuration MIMO signal sequence estimation apparatus 800 shown in FIG. 9 is used to estimate the transmitted signals. Based on this result, the estimation order calculation apparatus 801 determines the estimation order. Subsequently, the configuration of the simple configuration MIMO signal sequence estimation apparatus 800 is switched to the configuration of the MIMO signal sequence estimation apparatus 10 shown in FIG. 2, which adds the processing of the interference cancellation filter apparatuses 102 and the noise correction apparatus 104. After this switch, the transmitted signals may be estimated by the MIMO signal sequence estimation apparatus 10 shown in FIG. 2.

### [4-2: Effect of MIMO Signal Sequence Estimation Processing]

According to the present disclosure, in the successive interference cancellation technology related to MIMO signal sequence estimation, it is possible to reduce the computational cost required for determining the order of performing sequential processing, calculating the filter coefficient for estimating the transmitted signals, and calculating the filter coefficient for removing interfering signals. Furthermore, even in case where the transmitted signals estimated in the preceding stage contains errors, the noise correction processing of the present disclosure reduces the degradation in the accuracy of the interfering signals removal processing and reduces error propagation, enabling high-accuracy signal estimation.

### 5: Supplementary Note

With regard to the above-described embodiments, the following Supplementary Notes may also be described, but are not limited to the following.

### Supplementary Note 1

A signal processing apparatus that estimates a plurality of transmitted signal sequences corresponding each of a plurality of spatially multiplexed received signal sequences that interfere with each other, from the plurality of received signal sequences,
the signal processing apparatus comprising:
D (D is a positive integer) multiple-input single-output (MISO) filters, each of the D MIMO filters receives as input D data sequences, same number as the number of the plurality of received signal sequences, and outputs a single data sequence;
D interference cancellation filters, each of the D interference cancellation filters receives as input a single data sequence and D data sequences, and cancels interfering signals from the D data sequences using the single data sequence; wherein
the plurality of received signal sequences is first D received signal sequences,
each i-th (i is an integer between 1 and D) MISO filter included in the D MISO filters receives as input i-th D received signal sequences, and estimates a i-th single transmitted signal sequence included in D transmitted signal sequences,
each i-th interference cancellation filter included in the D interference cancellation filters receives as input a signal obtained by transforming a i-th single estimated transmitted signal sequence, which is an estimation result of the i-th single transmitted signal sequence, through a phase correction processing and a noise correction processing, and the i-th D received signal sequences, and cancels interference signals included in the i-th D received signal sequences, thereby outputting a i+1th D received signal sequences, and
the signal processing apparatus estimating the D transmitted signal sequences including the i-th single transmitted signal sequence.

### Supplementary Note 2

The signal processing apparatus according to Supplementary Note 1, wherein each of the D MISO filters includes:
D finite impulse response filters; and
an adder that adds up each of output signals output by each of the D finite impulse response filters.

### Supplementary Note 3

The signal processing apparatus according to Supplementary Note 1, wherein each of the D interference cancellation filters receives as input the single data sequence and the D data sequences, and includes:
a single-input multiple-output (SIMO) filter including D finite impulse response filters, each of the D finite impulse response filters receives the single data sequence as input and outputs D output signals; and
a subtractor that subtracts a corresponding output signal included the D output signals from each of the D data sequences.

### Supplementary Note 4

The signal processing apparatus according to Supplementary Note 1, wherein the noise compensation process transforms an input signal to a Quadratic Amplitude Modulation (QAM) signal point used to modulate the transmitted signal sequences or a signal point close to the QAM signal point, and outputs the signal transformed, wherein the noise compensation process includes:
decomposing the input signal into an in-phase component and a quadrature component,
performing a nonlinear transformation including a rectified linear function unit (ReLU) synthesis on each of the in-phase component and the quadrature component, and
outputting a signal that combines the in-phase component that has undergone the nonlinear transformation and the quadrature component that has undergone the nonlinear transformation.

### Supplementary Note 5

The signal processing apparatus according to Supplementary Note 2, wherein the signal processing apparatus comprises D filter coefficient update apparatuses that update filter coefficients of the D finite impulse response filters, wherein
a i-th filter coefficient update apparatus included in the D filter coefficient update apparatuses performs a product-sum operation using the i-th D received signal sequences and an error signal related to an output of the i-th MISO filter, and updates the filter coefficients of the i-th MISO filter.

### Supplementary Note 6

The signal processing apparatus according to Supplementary Note 3, wherein the signal processing apparatus comprises D filter coefficient update apparatuses that update filter coefficients of the D finite impulse response filters, wherein
a i-th filter coefficient update apparatus included in the D filter coefficient update apparatuses performs a product-sum operation using the i-th estimated transmitted signal sequence and an output signal of the D-th interference cancellation filter included in the D interference cancellation filters and updates filter coefficients of the SIMO filter of the i-th interference cancellation filter.

### Supplementary Note 7

The signal processing apparatus according to Supplementary Note 5, wherein
each of the D filter coefficient update apparatuses includes D filter coefficient memory units, D adders, D constant multipliers, and D multipliers,
each of the D filter coefficient update apparatuses:
multiplies each of the D data sequences by a single data sequence,
adds each of results of the predetermined constant multiplication process to each of the filter coefficients stored in the corresponding D filter coefficient memory units; and
updates the filter coefficients.

### Supplementary Note 8

The signal processing apparatus according to Supplementary Note 6, wherein
each of the D filter coefficient update apparatuses includes D filter coefficient memory units, D adders, D constant multipliers, and D multipliers,
each of the D filter coefficient update apparatuses:
multiplies each of the D data sequences by a single data sequence,
adds each of results of the predetermined constant multiplication process to each of the filter coefficients stored in the corresponding D filter coefficient memory units; and
updates the filter coefficients.

### Supplementary Note 9

The signal processing apparatus according to Supplementary Note 1, wherein the D MISO filters receive the first D received signal sequences as input and estimate the D transmitted signal sequences,
the signal processing apparatus comprising:
at least one memory storing instructions; and
at least one processor that is configured to execute instructions to:
calculate noise amount contained in each of the D estimated transmitted signal sequences obtained by performing the phase correction processing on each of the D output signals from the D MISO filters;
sort the D estimated transmitted signals in order of decreasing noise amount; and
perform estimation processing using the i-th MISO filter and outputs the i+1-th D received signal sequences using the i-th interference cancellation filter so as to estimate the single transmitted signal sequence in order of decreasing noise amount.

### Supplementary Note 10

A signal processing method executed by a signal processing apparatus that estimates a plurality of transmitted signal sequences corresponding each of a plurality of spatially multiplexed received signal sequences that interfere with each other, from the plurality of received signal sequences, the signal processing apparatus comprising: D (D is a positive integer) multiple-input single-output (MISO) filters, each of the D MIMO filters receives as input D data sequences, same number as the number of the plurality of received signal sequences, and outputs a single data sequence; D interference cancellation filters, each of the D interference cancellation filters receives as input a single data sequence and D data sequences, and cancels interfering signals from the D data sequences using the single data sequence; wherein the plurality of received signal sequences is first D received signal sequences,
the signal processing method comprising:
by each i-th (i is an integer between 1 and D) MISO filter included in the D MISO filters, receiving as input i-th D received signal sequences, and estimating a i-th single transmitted signal sequence included in D transmitted signal sequences;
by each i-th interference cancellation filter included in the D interference cancellation filters, receiving as input a signal obtained by transforming a i-th single estimated transmitted signal sequence, which is an estimation result of the i-th single transmitted signal sequence, through a phase correction processing and a noise correction processing, and the i-th D received signal sequences, and canceling interference signals included in the i-th D received signal sequences, thereby outputting a i+1th D received signal sequences; and
estimating the D transmitted signal sequences including the i-th single transmitted signal sequence.

### Supplementary Note 11

A non-transitory recording medium on which a computer program that allows a computer to execute the information processing method according to claim 10 is recorded.

The present disclosure may be appropriately modified within the scope that does not contradict the essence or concept of the invention as read from the claims and the entire specification. Such modified signal processing apparatus, signal processing method, and non-transitory recording mediums are also included within the technical concept of the present invention.

### DESCRIPTION OF REFERENCE NUMERALS

2 receiving apparatus
10, 80 signal processing apparatus
101 MISO filter apparatus
102 interference cancellation filter apparatus
103 phase correction unit
104 noise correction apparatus
201 filter
202 adder
301 filter
302 subtractor
401 transformation unit
500, 600 filter coefficient update apparatus
501 multiplier
502 constant multiplier
503 adder
504 filter coefficient storage unit
700 interference cancellation filter coefficient update apparatus
800 signal sequence estimation apparatus
801 estimation sequence calculation unit
802 noise amount calculation unit
803 comparison unit

What is claimed is:

1. A signal processing apparatus that estimates a plurality of transmitted signal sequences corresponding each of a plurality of spatially multiplexed received signal sequences that interfere with each other, from the plurality of received signal sequences,
the signal processing apparatus comprising:
D (D is a positive integer) multiple-input single-output (MISO) filters, each of the D MIMO filters receives as input D data sequences, same number as the number of the plurality of received signal sequences, and outputs a single data sequence;
D interference cancellation filters, each of the D interference cancellation filters receives as input a single data sequence and D data sequences, and cancels interfering signals from the D data sequences using the single data sequence; wherein
the plurality of received signal sequences is first D received signal sequences,
each i-th (i is an integer between 1 and D) MISO filter included in the D MISO filters receives as input i-th D received signal sequences, and estimates a i-th single transmitted signal sequence included in D transmitted signal sequences,
each i-th interference cancellation filter included in the D interference cancellation filters receives as input a signal obtained by transforming a i-th single estimated transmitted signal sequence, which is an estimation result of the i-th single transmitted signal sequence, through a phase correction processing and a noise correction processing, and the i-th D received signal sequences, and cancels interference signals included in the i-th D received signal sequences, thereby outputting a i+1th D received signal sequences, and
the signal processing apparatus estimating the D transmitted signal sequences including the i-th single transmitted signal sequence.

2. The signal processing apparatus according to claim 1, wherein each of the D MISO filters includes:
D finite impulse response filters; and
an adder that adds up each of output signals output by each of the D finite impulse response filters.

3. The signal processing apparatus according to claim 1, wherein each of the D interference cancellation filters receives as input the single data sequence and the D data sequences, and includes:
a single-input multiple-output (SIMO) filter including D finite impulse response filters, each of the D finite impulse response filters receives the single data sequence as input and outputs D output signals; and
a subtractor that subtracts a corresponding output signal included the D output signals from each of the D data sequences.

4. The signal processing apparatus according to claim 1, wherein the noise compensation process transforms an input signal to a Quadratic Amplitude Modulation (QAM) signal point used to modulate the transmitted signal sequences or a signal point close to the QAM signal point, and outputs the signal transformed, wherein the noise compensation process includes:
decomposing the input signal into an in-phase component and a quadrature component,
performing a nonlinear transformation including a rectified linear function unit (ReLU) synthesis on each of the in-phase component and the quadrature component, and
outputting a signal that combines the in-phase component that has undergone the nonlinear transformation and the quadrature component that has undergone the nonlinear transformation.

5. The signal processing apparatus according to claim 2, wherein the signal processing apparatus comprises D filter coefficient update apparatuses that update filter coefficients of the D finite impulse response filters, wherein
a i-th filter coefficient update apparatus included in the D filter coefficient update apparatuses performs a product-sum operation using the i-th D received signal sequences and an error signal related to an output of the i-th MISO filter, and updates the filter coefficients of the i-th MISO filter.

6. The signal processing apparatus according to claim 3, wherein the signal processing apparatus comprises D filter coefficient update apparatuses that update filter coefficients of the D finite impulse response filters, wherein
a i-th filter coefficient update apparatus included in the D filter coefficient update apparatuses performs a product-sum operation using the i-th estimated transmitted signal sequence and an output signal of the D-th interference cancellation filter included in the D interference cancellation filters and updates filter coefficients of the SIMO filter of the i-th interference cancellation filter.

7. The signal processing apparatus according to claim 5, wherein
each of the D filter coefficient update apparatuses includes D filter coefficient memory units, D adders, D constant multipliers, and D multipliers,
each of the D filter coefficient update apparatuses:
multiplies each of the D data sequences by a single data sequence,
adds each of results of the predetermined constant multiplication process to each of the filter coefficients stored in the corresponding D filter coefficient memory units; and
updates the filter coefficients.

8. The signal processing apparatus according to claim 6, wherein
each of the D filter coefficient update apparatuses includes D filter coefficient memory units, D adders, D constant multipliers, and D multipliers,
each of the D filter coefficient update apparatuses:
multiplies each of the D data sequences by a single data sequence,
adds each of results of the predetermined constant multiplication process to each of the filter coefficients stored in the corresponding D filter coefficient memory units; and
updates the filter coefficients.

9. The signal processing apparatus according to claim 1, wherein
the D MISO filters receive the first D received signal sequences as input and estimate the D transmitted signal sequences,
the signal processing apparatus comprising:
at least one memory storing instructions; and
at least one processor that is configured to execute instructions to:
calculate noise amount contained in each of the D estimated transmitted signal sequences obtained by performing the phase correction processing on each of the D output signals from the D MISO filters;
sort the D estimated transmitted signals in order of decreasing noise amount; and
perform estimation processing using the i-th MISO filter and outputs the i+1-th D received signal sequences using the i-th interference cancellation filter so as to estimate the single transmitted signal sequence in order of decreasing noise amount.

10. A signal processing method executed by a signal processing apparatus that estimates a plurality of transmitted signal sequences corresponding each of a plurality of spatially multiplexed received signal sequences that interfere with each other, from the plurality of received signal sequences, the signal processing apparatus comprising: D (D is a positive integer) multiple-input single-output (MISO) filters, each of the D MIMO filters receives as input D data sequences, same number as the number of the plurality of received signal sequences, and outputs a single data sequence; D interference cancellation filters, each of the D interference cancellation filters receives as input a single data sequence and D data sequences, and cancels interfering signals from the D data sequences using the single data sequence; wherein the plurality of received signal sequences is first D received signal sequences,
the signal processing method comprising:
by each i-th (i is an integer between 1 and D) MISO filter included in the D MISO filters, receiving as input i-th D received signal sequences, and estimating a i-th single transmitted signal sequence included in D transmitted signal sequences;
by each i-th interference cancellation filter included in the D interference cancellation filters, receiving as input a signal obtained by transforming a i-th single estimated transmitted signal sequence, which is an estimation result of the i-th single transmitted signal sequence, through a phase correction processing and a noise correction processing, and the i-th D received signal sequences, and canceling interference signals included in the i-th D received signal sequences, thereby outputting a i+1th D received signal sequences; and
estimating the D transmitted signal sequences including the i-th single transmitted signal sequence.

11. A non-transitory recording medium on which a computer program that allows a computer to execute the information processing method according to claim 10 is recorded.
